(19) United States
(12) Patent Application Publication
(10) Pub. No.: US 2024/0094171 A1
(43) Pub. Date: Mar. 21, 2024

(54) FRACTIONATING A SAMPLE CONTINUOUSLY

(71) Applicant: Wyatt Technology, LLC, Goleta, CA (US)

(72) Inventor: Steven P. Trainoff, Santa Barbara, CA (US)

(21) Appl. No.: 18/468,288

(22) Filed: Sep. 15, 2023

Related U.S. Application Data
(60) Provisional application No. 63/406,722, filed on Sep. 15, 2022.

(51) Int. Cl. G01N 30/00; G01N 1/40

(52) U.S. Cl. CPC G01N 30/0005; G01N 1/4005; G01N 2030/007

(57) ABSTRACT

A continuous field flow fractionator includes a sample inject port, a frit inlet port, a first fraction outlet port, a second fraction outlet port, and a third fraction outlet port. A first flow out of the first fraction outlet port is configured to extract a sample-free solvent. A second flow out of the second fraction outlet port is configured to extract an increased concentration of small molecules of a sample. A third flow out of the third faction port is configured to extract a remainder of the sample.

### PRIORITY

This application claims priority to U.S. Provisional Patent Application No. 63/406,722, filed Sep. 15, 2022, and titled “FRACTIONATING A SAMPLE CONTINUOUSLY.”

### BACKGROUND

The present disclosure relates to field flow fractionators, and more specifically, to a field flow fractionator.

### SUMMARY

In one embodiment, a computer implemented method includes executing, by a computer system, a set of logical operations injecting a sample in a continuous flow into a sample inject port of a continuous field flow fractionator (CFFF). The method includes executing, by a computer system, a set of logical operations injecting a continuous flow of pure solvent into a frit inlet port of the CFFF sufficient to force the sample toward a membrane of the CFFF. The method further includes executing, by a computer system, a set of logical operations establishing an exponential concentration profile for a plurality of fractions or species of the sample with respect to a distance from the membrane and executing, by a computer system, a set of logical operations controlling a first flow out of a first fraction outlet port, wherein the first flow includes a portion of the sample having at least one of the plurality of fractions. The method further includes executing, by a computer system, a set of logical operations extracting a remainder of the sample from a second fraction outlet port of the CFFF.

In one embodiment, a continuous field flow fractionator (CFFF) includes a sample inject port, a frit inlet port, a first fraction outlet port, a second fraction outlet port, and a third fraction outlet port. A first flow out of the first fraction outlet port is configured to extract a sample-free solvent. A second flow out of the second fraction outlet port is configured to extract an increased concentration of small molecules of a sample. A third flow out of the third faction outlet port is configured to extract a remainder of the sample.

In another embodiment, a continuous field flow fractionator (CFFF) system includes a plurality of continuous field flow fractionators (CFFFs) connected together. Each of the CFFFs include a sample inject port, a frit inlet port, a first fraction outlet port, a second fraction outlet port, and a third fraction outlet port. A first flow out of the first fraction outlet port is configured to extract a sample-free solvent. A second flow out of the second fraction outlet port is configured to extract an increased concentration of small molecules of a sample. A third flow out of the third faction outlet port is configured to extract a remainder of the sample.

### BRIEF DESCRIPTION OF THE DRAWINGS

The above and further advantages of this invention may be better understood by referring to the following description in conjunction with the accompanying drawings, in which like reference numerals indicate like elements and features in the various figures. For clarity, not every element may be labeled in every figure. The drawings are not necessarily to scale, emphasis instead being placed upon illustrating the principles of the invention.

FIG. 1 depicts a schematic side view of a prior art field flow fractionator.

FIG. 2 depicts a schematic side view of a field flow fractionator, in accordance with one embodiment.

FIG. 3 depicts a schematic side view of a further field flow fractionator, in accordance with one embodiment.

FIG. 4 depicts a schematic representation of a cascading continuous fractionation system, in accordance with one embodiment.

FIG. 5 depicts a traditional channel shape of a field flow fractionator, along with a graph showing a uniform field over a length of the channel, in accordance with one embodiment.

FIG. 6 depicts a schematic side view of a further field flow fractionator applying an electric field, in accordance with one embodiment.

FIG. 7 depicts a schematic side view of a further field flow fractionator utilizing recirculation, in accordance with one embodiment.

FIG. 8 depicts a computer system for performing field flow fractionation with one or more of the field flow fractionators disclosed herein, in accordance with one embodiment.

### DETAILED DESCRIPTION

Reference in the specification to “one embodiment” or “an embodiment” means that a particular, feature, structure or characteristic described in connection with the embodiment is included in at least one embodiment of the teaching. References to a particular embodiment within the specification do not necessarily all refer to the same embodiment.

The present teaching will now be described in more detail with reference to exemplary embodiments thereof as shown in the accompanying drawings. While the present teaching is described in conjunction with various embodiments and examples, it is not intended that the present teaching be limited to such embodiments. On the contrary, the present teaching encompasses various alternatives, modifications and equivalents, as will be appreciated by those of skill in the art. Those of ordinary skill having access to the teaching herein will recognize additional implementations, modifications and embodiments, as well as other fields of use, which are within the scope of the present disclosure as described herein.

### Definitions

Particle

A particle may be a constituent of a liquid sample aliquot. Such particles may be molecules of varying types and sizes, nanoparticles, virus like particles, liposomes, emulsions, bacteria, and colloids. These particles may range in size on the order of nanometer to microns.

Analysis of Macromolecular or Particle Species in Solution

The analysis of macromolecular or particle species in solution may be achieved by preparing a sample in an appropriate solvent and then injecting an aliquot thereof into a separation system such as a liquid chromatography (LC) column or field flow fractionation (FFF) channel where the different species of particles contained within the sample are separated into their various constituencies. Once separated, generally based on size, mass, or column affinity, the samples may be subjected to analysis by means of light scattering, refractive index, ultraviolet absorption, electrophoretic mobility, and viscometric response.

Field Flow Fractionation (FFF)

The separation of particles in a solution by means of field flow fractionation, FFF, was studied and developed extensively by J. C. Giddings beginning in the early 1960s. The basis of these techniques lies in the interaction of a channel-constrained sample and an impressed field applied perpendicular to the direction of flow. Among those techniques of current interest is cross flow FFF, often called symmetric flow (SFlFFF), where an impressed field is achieved by introducing a secondary flow perpendicular to the sample borne fluid within the channel. There are several variations of this technique including asymmetric flow FFF (i.e., A4F), and hollow fiber (H4F) flow separation.

Other FFF techniques include (i) sedimentation FFF (SdFFF), where a gravitational/centrifugal cross force is applied perpendicular to the direction of the channel flow, (ii) electrical FFF (EFFF), where an electric field is applied perpendicular to the channel flow, and (ii) thermal FFF (ThFFF), where a temperature gradient is transversely applied.

Common to all these methods of field flow fractionation is a fluid, or mobile phase, into which is injected an aliquot of a sample whose separation into its constituent fractions is achieved by the application of a cross field. Many of the field flow fractionators allow for the control and variation of the strength of the cross field during the time the sample aliquot flows down the channel, be it electrical field, cross flow, thermal gradient, or other variable field.

### Overview

Field flow fractionators are primarily used for analytical separations. In the typical application, an aliquot of a polydisperse sample is injected into the channel and after time, the individual fractions elute separated in time. The typical injection quantities are milligrams of sample. It is common to collect the fractions in vials and one can make several runs in order to increase the quantity of the fractionated material in each vial. However, the method is inherently batch: Inject, Fractionate, Analyze, and Collect.

Known analytical FFF methods do not scale well to preparative applications that require gram or kilogram quantities. Present embodiments described herein seek to rectify these deficiencies and provide FFF methods and fractionators which can operate continuously and at much higher quantities than prior known methods. There are many applications where preparative applications on larger scales would be desirable. For example, present embodiments described herein may be deployed to use FFF to generate gram quantities of fractionated material in order to prepare therapeutic doses of a drug product. Alternatively, present embodiments may be utilized to purify bio-nanoparticles into fractions with a narrow size or charge range that are characterized by other methods that require large amounts of material. A third application of embodiments disclosed herein may be to polish a large sample to remove small molecules (e.g., impurities), and/or large aggregates.

Using known analytical FFF methods and systems, such applications would require an array of many fractionators and be prohibitively expensive and unwieldy. The present embodiments described herein seek to provide a device that can operate in a continuous fractionation mode into which one supplies a feed of sample and recovers the sample from two or more ports that output different sub-fractions. In this mode, the amount of fractionated sample increases over time and can thereby accumulate large quantities of product. Providing FFF systems and methods to run in a contiguous fractionation mode is the subject of the present disclosure.

Thus, disclosed are various methods whereby an analytical FFF system, which is used for fractionating small aliquots of sample, can be adapted to operate in a continuous fraction mode. Such a mode can process much larger quantities of sample and may be scalable to address preparative fraction needs. Present systems can be cascaded or otherwise connected in parallel or series to improve the number of distinct fractions or to improve the purity of the sample that is collected from each port. For example, present systems can be run in parallel to improve the total capacity of a sample that can be fractionated, for example. Present systems can be run in series to improve the fraction purity.

In the disclosed continuous FFF based fractionator, the basic mechanism is the interplay between a field that drives the sub-fractions of a sample towards an accumulation wall, and diffusion that lifts the sub-fractions off the wall and gives rise to differing exponential concentration decays as a function of distance from the accumulation wall.

### EXAMPLE EMBODIMENTS

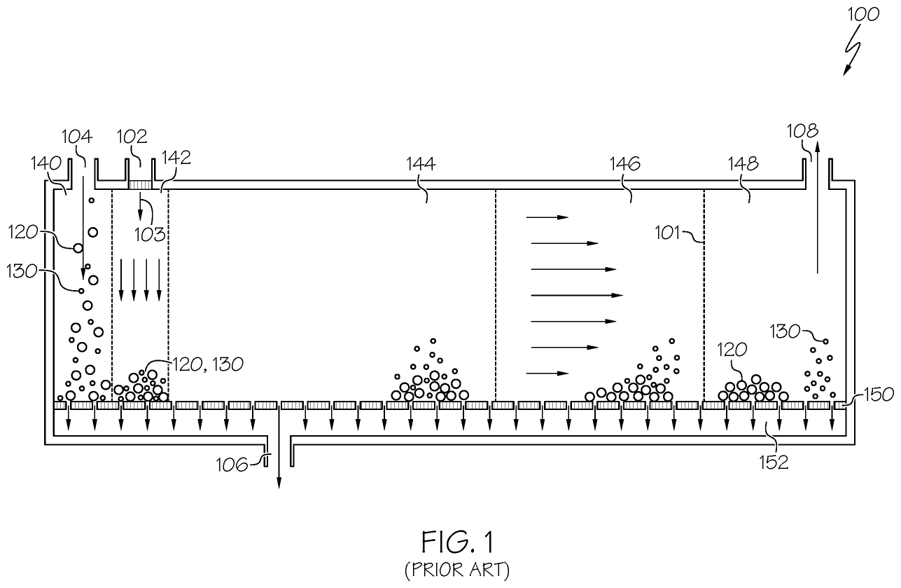

FIG. 1 depicts a schematic side view of a prior art field flow fractionator 100. Specifically, the FFF 100 includes a channel 101 having a frit inlet port 102, a sample inject port 104, a cross-flow port 106, and a fraction output port 108. In the example embodiment, the channel 101 may be between 250 and 900 μm in height, and may have an appropriate channel length to provide enough distance for FFF separation to occur.

As shown, an unseparated sample is provided into the channel 101 of the FFF 100. The unseparated sample includes a sample having multiple constituent parts—for example comprising large sized particles 120 and small sized particles 130. The bottom of the channel 101 includes a membrane 150 configured to prevent sample from moving therethrough, and a porous frit 152 located below the membrane 150 between the membrane 150 and the cross-flow port 106 configured to allow solvent to outlet from the channel.

In this example, the frit inlet port 102 provides solvent into the channel 101 which pushes the unseparated sample 120, 130 coming from the sample inject port 104 toward the membrane 150 at an inlet section 140 of the channel 101. Downward fluidic pressure toward the membrane is caused by the combination of the inlets 102, 104, and the cross-flow port 106. In a cross-flow section 142, the unseparated sample 120, 130 begins to congregate toward the membrane 150. Slowly, the unseparated sample 120, 130 moves rightward along the channel 101 toward the sample output port 108.

As the unseparated sample 120, 130 travels downstream. The large particles 120 experience high Stokes forces toward the wall and are lifted upward by relatively weak diffusion flux. In contrast, small particles experience a relatively weak Stokes force downward and a high diffusion force upwards. By the time they have reached section 144 they have achieved an equilibrium in which each sample sub-fraction has its highest concentration on the accumulation wall, and concentration falls exponentially with distance from the wall. The exponential decay length of the small particles is therefore larger than the exponential decay length of the large particles.

As a result of the above-described principles, the small particles are more diffusive and reach the end of the channel 101 first. In particular, the channel 101 includes a separated sample section 148, which the separated small particles 130 reach first, followed by the separated large particles 120. Once the sample reaches the end of the channel 101, the separated particles are pulled out of the channel 101 through the sample output port 108.

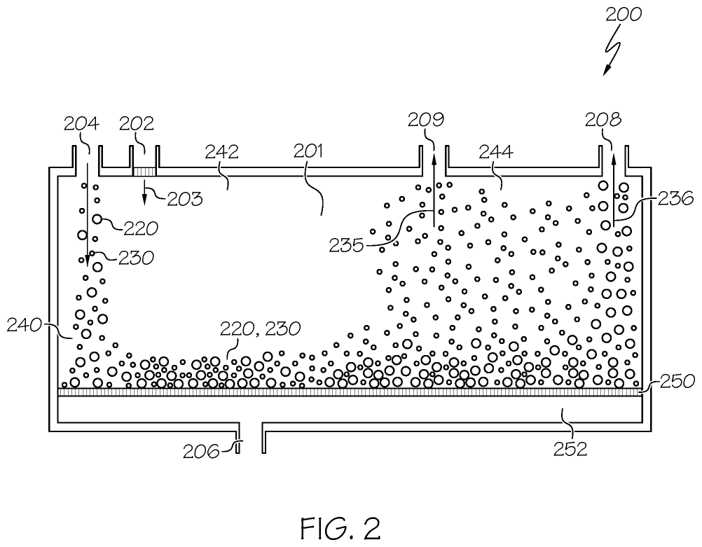

FIG. 2 depicts a schematic side view of a Continuous Field Flow Fractionator (CFFF) 200, in accordance with one embodiment. As shown, the field flow fractionator 200 may be operating in continuous fractionation mode, whereby no state changes between modes of operation (i.e. changing between focus mode and elute mode) are conducted. Instead, the field flow fractionator 200 may be configured to operate continuously in elution-inject mode and may not change states during this continuous operation.

As shown, the CFFF 200 includes a channel 201 having a frit inlet port 202, a sample inject port 204, a cross-flow port 206, and a first fraction output port 209. In addition, the CFFF 200 includes a second fraction output port 208. The CFFF 200 may include a length which is generally smaller than the FFF 100, in some embodiments. Moreover, the flows of the CFFF 200 may be configured to create an inlet section 240, a cross flow section 242, and a diffusion and/or parabolic channel flow section 244. The CFFF 200 may thus not include a separated sample section which collects separated sample, such as the separated sample section 148 of the FFF 100. Instead, separation may occur continuously via the particular outlets 208, 209 the fraction leaves the channel 201 through, as described herein below.

The CFFF 200 may be a continuous FFF that is configured to inject a sample 220, 230 in a continuous flow into the sample inject port 204 of the channel 201 of the CFFF 200. At the same time, the CFFF 200 may be configured to inject a continuous flow of pure solvent 203 into the frit inlet port 202 of the CFFF 200 sufficient to force the sample 220, 230 toward a membrane 250 at a bottom of the channel 201. The sample 220, 230 may include a first fraction 220 of particles of a first size, and a second fraction 230 of particles of a second smaller size.

The CFFF 200 may further be configured to establish an exponential concentration profile for a plurality of fractions or species (i.e. the fraction 220 and the fraction 230) of the sample 220, 230 with respect to a distance from the membrane 250. In particular, the exponential concentration profile may be defined by the upward diffusion force and the downward Stokes force, whereby the second fraction 230 of smaller particles may diffuse further to the top the channel 201 than the first fraction 220 of larger particles.

The CFFF 200 may thus be configured to control a first flow 235 out of the first fraction outlet port 209. The first flow 235 may include a portion of the sample 220, 230 having at least one of the plurality of fractions. In particular, the first flow 235 may include particles of the second fraction 230 but may not include particles of the first fraction 220. This may be because the particles of the first fraction 220 experience higher Stokes forces and remain closer to the membrane 250 at the bottom of the channel 201 relative to the smaller particles of the second fraction 230.

The CFFF 200 may further be configured to extract a remainder 236 of the sample 220, 230 from the second fraction outlet port 208 of the CFFF 200. The remainder 236 may include both particles of the first fraction 220 and the remaining particles of the second fraction 230 which were not already extracted out of the first flow 235 through the first fraction outlet port 209.

Reviewing the structure shown, as the CFFF 200 increases the first flow 235 through the first fraction outlet port 209, upper layers of the sample profile are extracted through the first fraction outlet port 209. This is because the small particles of the second fraction 230 being pulled from the channel 201 through the first fraction outlet port 209 may include a larger exponential decay length than the larger particles of the first fraction 220. This first flow 235 may thus be configured, via a properly assigned outlet flow rate, to ensure no large particles are included in the first flow 235. However, the second fraction outlet port 208 located down-channel will extract the remaining population of particles consisting of the large particles of the first fraction 220, and the remaining small particles of the second fraction 230 that were not extracted. The CFFF 200 may thus be configured to operate and run in a continuous fractionation mode.

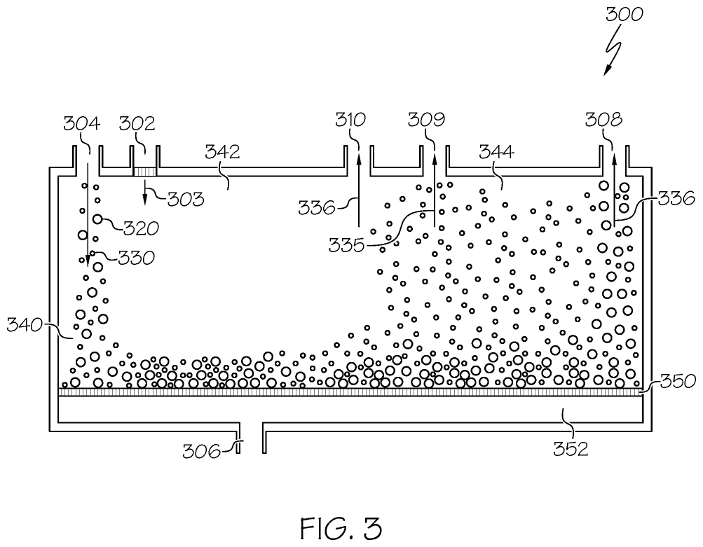

FIG. 3 depicts a schematic side view of a further continuous field flow fractionator (CFFF) 300, in accordance with one embodiment. The CFFF 300 may be the same or similar in operation to the CFFF 200 described herein above. Thus, the CFFF 300 includes a channel 301 having a frit inlet port 302, a sample inject port 304, and cross-flow port 306. Unlike the CFFF 200, the CFFF 300 includes three ports, including a first output port 310, a second fraction output port 309, and a third fraction output port 308. Moreover, the flows of the CFFF 300 may be configured to create an inlet section 340, a cross flow section 342, and a diffusion and/or parabolic channel flow section 344. The CFFF 300 may thus not include a separated sample section which collects separated sample, such as the separated sample section 148 of the FFF 100. Instead, separation may occur continuously via the particular outlets 308, 309, 310 the fraction leaves the channel 301 through, as described herein below.

Like the CFFF 200, the CFFF 300 may be a continuous FFF that is configured to inject a sample 320, 330 in a continuous flow into the sample inject port 304 of the channel 301. At the same time, the CFFF 300 may be configured to inject a continuous flow of pure solvent 303 into the frit inlet port 302 of the CFFF 300 sufficient to force the sample 320, 330 toward a membrane 350 at a bottom of the channel 301. The sample 320, 330 may include a first fraction 320 of particles of a first size, and a second fraction 330 of particles of a second smaller size.

The CFFF 200 may further be configured to establish an exponential concentration profile for a plurality of fractions or species (i.e. the fraction 320 and the fraction 330) of the sample 320, 330 with respect to a distance from the membrane 350. In particular, the exponential concentration profile may be defined by the upward diffusion force and the downward Stokes force, whereby the second fraction 330 of smaller particles may diffuse further to the top the channel 301 than the first fraction 320 of larger particles.

The CFFF 300 may thus be configured to control a first flow 336 out of a first outlet port 310. The first flow may be a sample-free flow containing pure solvent, in some embodiments. The first outlet port 310 may thus help to increase the concentration of the solvent down-channel from the first outlet port 310 by removing pure solvent through the first flow 336.

The CFFF 300 may further be configured to control a second flow 335 out of the second fraction outlet port 309. The second flow 335 may include a portion of the sample 320, 330 having at least one of the plurality of fractions. In particular, the second flow 335 may include particles of the second fraction 330 but may not include particles of the first fraction 320. This may be because the particles of the first fraction 320 experience higher Stokes forces and remain closer to the membrane 350 at the bottom of the channel 301 relative to the smaller particles of the second fraction 330.

The CFFF 300 may further be configured to extract a remainder 336 of the sample 320, 330 from the second fraction outlet port 308 of the CFFF 300. The remainder 336 may include both particles of the first fraction 320 and the remaining particles of the second fraction 330 which were not already extracted out of the first flow 335 through the first fraction outlet port 309.

While the CFFF 300 includes three outlet ports 308, 309, 310, any number of outlet ports may be provided. For example, it is contemplated for a CFFF to include more than one outlet port configured to receive a flow of sample free solvent. For example, CFFFs contemplated herein may include multiple output streams by having multiple of such ports that extract progressively lower fluid streams.

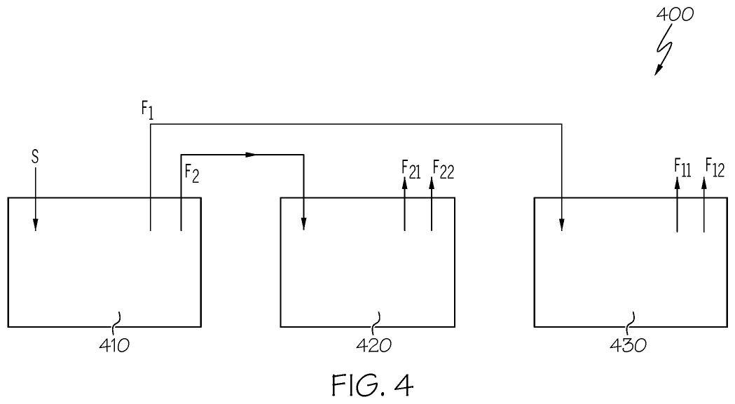

FIG. 4 depicts a schematic representation of a cascading continuous fractionation system 400, in accordance with one embodiment. As shown, the cascading continuous fractionation system 400 includes a first CFFF 410, a second CFFF 420, and a third CFFF 430. In such a system, each of the CFFFs 410, 420, 430 may operate in a manner consistent with the CFFFs 200, 300 described hereinabove, and may be configured to cascade the elution from the continuous fluid streams into new channels which then fractionate them further. To achieve this, each of the flows for the different fractions may be individually controlled with a flow controller system, such as the computer system 800 (described herein below) and associated computer-controllable flow controllers. The flow controllers may be configured to control flows on F1, F2, F21, and F11, and the frit inlet flows (not shown) for each fractionator. The remaining flows F22, F12 may be set by the difference between the controlled inlet and outlet flows for each respective fractionator (CFFF 420 and CFFF 430). In the embodiment shown, the first output F1 of the first fractionator 410 can be sent to the second fractionator 420, and the second output F2 of the first fractionator 410 can be sent to the third fractionator 430. Thus, fractions F21, F22 are further fractions of F2, and F11, F12 are further fractions of F1.

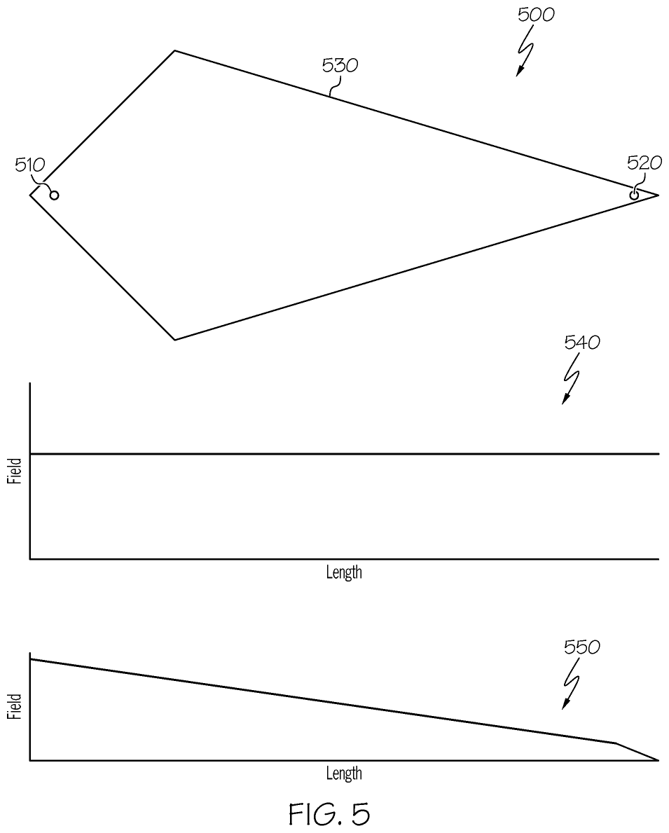

FIG. 5 depicts a traditional channel shape 500 of a field flow fractionator, along with a graph 540 showing a uniform field over a length of the channel, in accordance with one embodiment. The traditional channel shape 500 may be deployed by attaching together a top portion and a bottom portion of a structure where a channel is defined between the top and bottom portions. The traditional channel design uses a trapezoidal channel design shape 530 having an inlet 510 at one end and an outlet 520 at an opposing end. Such a design may be configured to create a uniform flow field through the bottom membrane as fluid is lost into the cross flow port as the sample moves from right to left within the channel.

Various embodiments are contemplated in which non-uniform flow fields are achieved. One example of a non-uniform flow field is shown including a decreasing field 550 over the length of the channel. In such an embodiment, the field is high at the beginning of the channel and low at the exit. In contemplated embodiments, it may be possible to define a plurality of zones through the channel that can be individually controlled to give different cross flows. Using such an approach, the CFFFs described herein may produce a spatial gradient that is large near the inlet and decays as one travels downstream, rather than a uniform gradient as shown in FIG. 5. With a reduced cross flow, the Stokes force towards the accumulation wall decreases and the corresponding exponential decay length increases. If the exponential decay length for any particle size grows to become comparable to the dimension of the channel, it is no longer retained near the accumulation wall. Therefore, each size subpopulation will become unbound from the accumulation wall at different distances downstream.

For example, it is contemplated that the CFFFs described herein may adjust the cross flow so that the small particles release from the accumulation wall half way down the channel while the large particles still will be retained on the accumulation wall. Then, the intermediate sizes may release further downstream and the large ones will release near the exit. This may improve the resolution of the fractionations collected in each of the various fraction outlet ports of the CFFFs described herein.

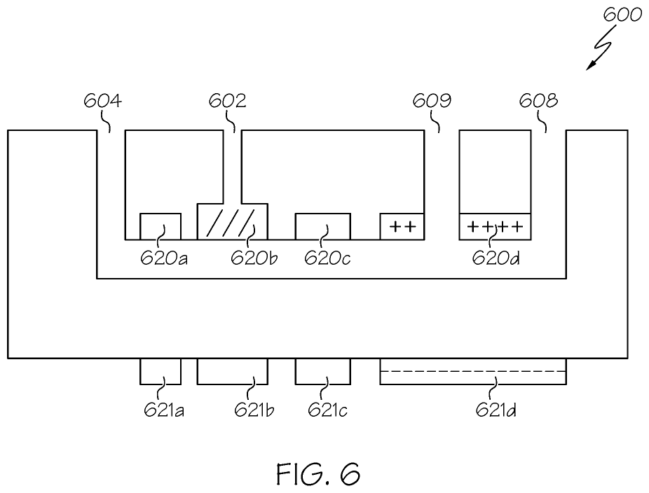

FIG. 6 depicts a schematic side view of a further continuous field flow fractionator (CFFF) 600 applying an electric field, in accordance with one embodiment. Thus, rather than introducing a field gradient through the geometric shape of the channel, it is possible to make a channel having a number of different zones that can apply different electrical fields at different locations along a length of the channel. For example, it is possible to apply a high net field near the entrance of the channel which decreases along the channel. In this case, the electrical field can be adjusted to oppose the Stokes force for some charged fractions. In this configuration, all of the sub-fractions may be configured to feel the Stokes force that drives them toward the membrane at the bottom of the channel. However, different fractions may be released from the accumulation wall. At varying locations downstream, the electrical field can be adjusted to overcome the Stokes for some fractions, but not others. In this configuration, the separation occurs on a combination of size and the size to charge ratio. It is contemplated that many zones may be deployed, with any desired field configuration. It is also contemplated to use a single set of electrodes near the channel to apply a field that releases sub-fractions with a high charge to size ratio.

Thus, the CFFF 600 may represent any of the CFFFs described herein, and includes a channel 601 having a sample inject port 604, a frit inlet port 602 and a plurality of outlet ports, such as the first outlet port 609 and the second outlet port 608. As shown, the CFFF 600 includes a plurality of positive electrodes 620a, 620b, 620c, 620d located above the channel 601 in a top portion of the CFFF 600, and a plurality corresponding negative electrodes 621a, 621b, 621c, 621d located below the channel 601 in a bottom portion of the CFFF 600. Thus, adding electrical fields into the channel 601 is accomplished by adding pairs of conducting pads, including a first pair 620a, 621a, a second pair 620b, 621b, a third pair 620c, 621c, and a fourth pair 620d, 621d to the top and bottom, respectively, of an otherwise electrically insulated channel. Applying a voltage through the electrodes 620, 621 provides an electrical field gradient. While four pairs of electrodes are shown for exemplary purposes, any number of electrode pairs may be incorporated into the CFFFs described herein.

While not shown, it is further contemplated to provide other fields to facilitate fractionation designs. For example, it may be possible to add a temperature gradient to part of the channel to perform a hybrid flow/thermal CFFF to allow the releasing of fractions. In this case, regions of the upper portion or upper plate of the fractionator may be heated, and regions of the lower plate may be cooled to provide a temperature gradient. Like pure thermal FFF, this hybrid configuration may fractionate sub-fractions based on their size and Soret coefficient.

The fields in the present embodiments described herein may be configured to act in a vertical direction with respect to the channel and actually move the sample away from the accumulation wall, rather than providing a perpendicular direction to facilitate driving the sample to separate along the accumulation wall.

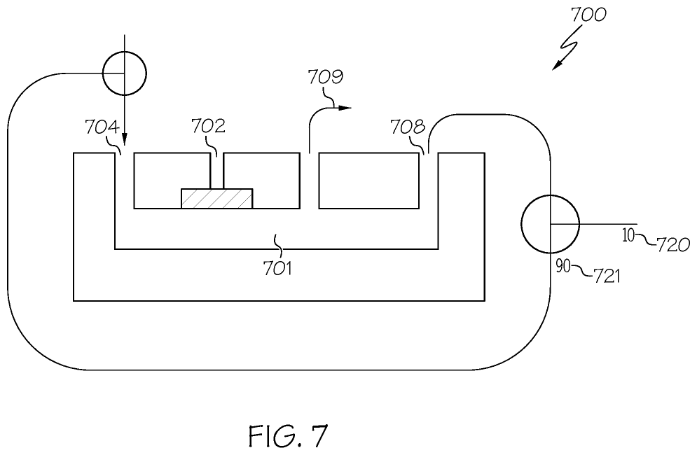

FIG. 7 depicts a schematic side view of a further field flow fractionator (CFFF) 700 utilizing recirculation, in accordance with one embodiment. The CFFF 700 displays that it is contemplated to recirculate some of the fractionated samples to improve purity, in some embodiments. The CFFF 700 includes a sample inject port 704, a frit inlet port 702, a first fraction outlet port 709, and a second fraction outlet port 708, similar to the CFFF 200.

As shown in the CFFF 700, a detector port 708 will receive mostly large particles with a mixture of some smaller particles, based on the principles described herein above. Unlike the CFFF 200, the present CFFF 700 may be configured to direct a ninety percent (90%) portion 721 of the sample received by the detector port (i.e., the second fraction outlet port 708) back to the input stream, and pass only a ten percent (10%) portion 720 of the sample received by the detector port 708 to the detector. By providing the ninety percent portion 721 back to the sample inject port 704, more of the small particles can be removed through the first fraction outlet port 709. While a 90%/10% ratio is contemplated for the recirculation and reinjection, any appropriate ratio is contemplated. A ratio can be changed in order to increase or decrease the number of passes, for example.

### Methodology

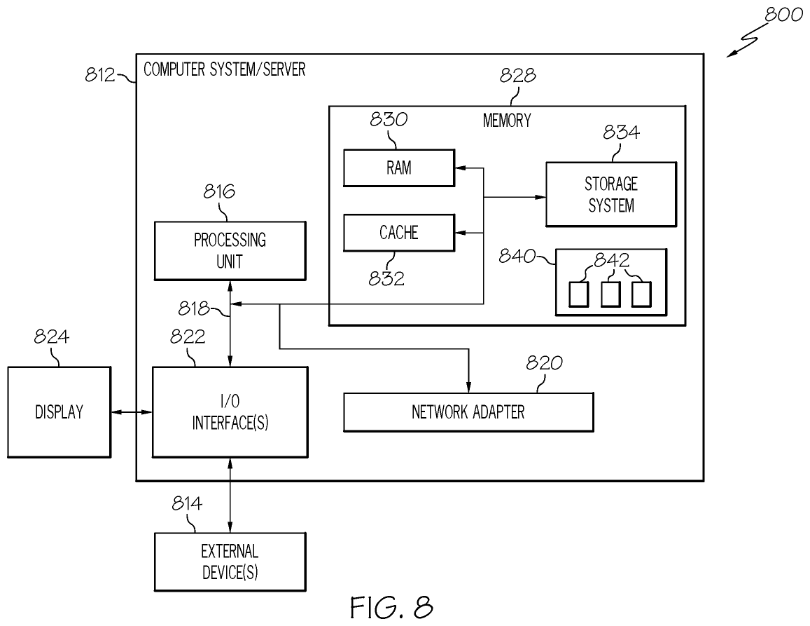

Various methods are contemplated for performing continuous FFF separation. These methods may be implemented by executing a set of logical operations by a computer system, or with the controlling operations of a computer system (such as the computer system 800 shown in FIG. 8 and described below) in order to achieve the functionality and/or control the FFFs to produce the functionality described in the methods. Thus, the methods may be performable by one or more of the example embodiments of the continuous FFFs described herein above and shown in FIGS. 2-7.

Methods include, for example, executing, by a computer system, a set of logical operations injecting a sample in a continuous flow into a sample inject port of a continuous field flow fractionator (CFFF) such as the CFFF 200, 300, 410, 420, 430, 600, 700. Methods may include executing, by the computer system, a set of logical operations injecting a continuous flow of pure solvent into a frit inlet port, such as one of the ports 202, 302, 602, 702 described herein above, of the CFFF sufficient to force the sample toward a membrane of the CFFF. Methods may include executing, by the computer system, a set of logical operations establishing an exponential concentration profile for a plurality of fractions or species of the sample with respect to a distance from the membrane. Methods may further include executing, by the computer system, a set of logical operations controlling a first flow out of a first fraction outlet port, such as one of the ports 209, 309 described herein above. The first flow includes a portion of the sample having at least one of the plurality of fractions, such as a fraction comprising a small particle size. The method then includes executing, by the computer system, a set of logical operations extracting a remainder of the sample from a second fraction outlet port of the CFFF, such as one of the ports port 208, 308 described herein above.

Methods further include executing, by the computer system, a set of logical operations controlling a flow of sample-free solvent out of a third outlet port of the CFFF, such as the outlet 310. The third outlet port may be located proximate the sample inject port relative to the first fraction outlet port and the second fraction outlet port.

Methods may further include executing, by the computer system, a set of logical operations recirculating a portion of the remainder sample from the second fraction outlet port back to the sample inject port, as shown in the CFFF 700.

Methods may further include executing, by the computer system, a set of logical operations applying an electric field to one or more zones within a channel of the CFFF by controlling at least one pair of electrodes, as shown in the CFFF 600.

Methods may further include executing, by the computer system, a set of logical operations applying temperature gradient to one or more zones within a channel of the CFFF by controlling at least one of a heater and cooler attached to at least one of a top portion and a bottom portion of the CFFF.

Methods may further include executing, by the computer system, a set of logical operations directing the first flow out of the first fraction outlet port to a sample inject port of a second continuous field flow fractionator (CFFF), and/or further executing, by the computer system, a set of logical operations directing the second flow out of the second fraction outlet port to a sample inject port of a third continuous field flow fractionator (CFFF), as shown in the system 400 of FIG. 4.

### Computer System

FIG. 8 depicts a computer system 800 for performing field flow fractionation with one or more of the field flow fractionators disclosed herein, in accordance with one embodiment. Computer system 800 is only one example of a computer system and is not intended to suggest any limitation as to the scope of use or functionality of embodiments of the present invention. Regardless, computer system 800 is capable of being implemented to perform and/or performing any of the functionality/operations of the present invention.

Computer system 800 includes a computer system/server 812, which is operational with numerous other general purpose or special purpose computing system environments or configurations. Examples of well-known computing systems, environments, and/or configurations that may be suitable for use with computer system/server 812 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices.

Computer system/server 812 may be described in the general context of computer system-executable instructions, such as program modules, being executed by a computer system. Generally, program modules may include routines, programs, objects, components, logic, and/or data structures that perform particular tasks or implement particular abstract data types. Computer system/server 812 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 8, computer system/server 812 in computer system 800 is shown in the form of a general-purpose computing device. The components of computer system/server 812 may include, but are not limited to, one or more processors or processing units 816, a system memory 828, and a bus 818 that couples various system components including system memory 828 to processor 816.

Bus 818 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 812 typically includes a variety of computer system readable media. Such media may be any available media that is accessible by computer system/server 812, and includes both volatile and non-volatile media, removable and non-removable media.

System memory 828 can include computer system readable media in the form of volatile memory, such as random access memory (RAM) 830 and/or cache memory 832. Computer system/server 812 may further include other removable/non-removable, volatile/non-volatile computer system storage media. By way of example only, storage system 834 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 818 by one or more data media interfaces. As will be further depicted and described below, memory 828 may include at least one program product having a set (e.g., at least one) of program modules that are configured to carry out the functions/operations of embodiments of the invention.

Program/utility 840, having a set (at least one) of program modules 842, may be stored in memory 828 by way of example, and not limitation. Exemplary program modules 842 may include an operating system, one or more application programs, other program modules, and program data. Each of the operating system, one or more application programs, other program modules, and program data or some combination thereof, may include an implementation of a networking environment. Program modules 842 generally carry out the functions and/or methodologies of embodiments of the present invention.

Computer system/server 812 may also communicate with one or more external devices 814 such as a keyboard, a pointing device, a display 824, one or more devices that enable a user to interact with computer system/server 812, and/or any devices (e.g., network card, modem, etc.) that enable computer system/server 812 to communicate with one or more other computing devices. Such communication can occur via Input/Output (I/O) interfaces 822. Still yet, computer system/server 812 can communicate with one or more networks such as a local area network (LAN), a general wide area network (WAN), and/or a public network (e.g., the Internet) via network adapter 820. As depicted, network adapter 820 communicates with the other components of computer system/server 812 via bus 818. It should be understood that although not shown, other hardware and/or software components could be used in conjunction with computer system/server 812. Examples, include, but are not limited to: microcode, device drivers, redundant processing units, external disk drive arrays, RAID systems, tape drives, and data archival storage systems.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the invention has been shown and described with reference to specific embodiments, it should be understood by those skilled in the art that various changes in form and detail may be made therein without departing from the spirit and scope of the invention as recited in the accompanying claims.

What is claimed is:

1. A computer implemented method comprising:
executing, by a computer system, a set of logical operations injecting a sample in a continuous flow into a sample inject port of a continuous field flow fractionator;
executing, by the computer system, a set of logical operations injecting a continuous flow of pure solvent into a frit inlet port of the continuous field flow fractionator sufficient to force the sample toward a membrane of the continuous field flow fractionator;
executing, by the computer system, a set of logical operations establishing an exponential concentration profile for a plurality of fractions or species of the sample with respect to a distance from the membrane;
executing, by the computer system, a set of logical operations controlling a first flow out of a first fraction outlet port, wherein the first flow includes a portion of the sample having at least one of the plurality of fractions; and
executing, by the computer system, a set of logical operations extracting a remainder of the sample from a second fraction outlet port of the continuous field flow fractionator.

2. The computer implemented method of claim 1, further comprising:
executing, by the computer system, a set of logical operations controlling a flow of sample-free solvent out of a third outlet port of the continuous field flow fractionator, wherein the third outlet port is located proximate the sample inject port relative to the first fraction outlet port and the second fraction outlet port.

3. The computer implemented method of claim 1, further comprising:
executing, by the computer system, a set of logical operations recirculating a portion of the remainder sample from the second fraction outlet port back to the sample inject port.

4. The computer implemented method of claim 1, further comprising:
executing, by the computer system, a set of logical operations applying an electric field to one or more zones within a channel of the continuous field flow fractionator by controlling at least one pair of electrodes.

5. The computer implemented method of claim 1, further comprising:
executing, by the computer system, a set of logical operations applying temperature gradient to one or more zones within a channel of the continuous field flow fractionator by controlling at least one of a heater and cooler attached to at least one of a top portion and a bottom portion of the continuous field flow fractionator.

6. The computer implemented method of claim 1, further comprising:
executing, by the computer system, a set of logical operations directing the first flow out of the first fraction outlet port to a sample inject port of a second continuous field flow fractionator.

7. The computer implemented method of claim 6, further comprising:
executing, by the computer system, a set of logical operations directing the second flow out of the second fraction outlet port to a sample inject port of a third continuous field flow fractionator.

8. A continuous field flow fractionator comprising:
a sample inject port;
a frit inlet port;
a first outlet port;
a second fraction outlet port; and
a third fraction outlet port,
wherein a first flow out of the first outlet port is configured to extract a sample-free solvent,
wherein a second flow out of the second fraction outlet port is configured to extract an increased concentration of small molecules of a sample, and
wherein a third flow out of the third faction port is configured to extract a remainder of the sample.

9. The continuous field flow fractionator of claim 8, further comprising:
a top portion, wherein the sample inject port, the frit inlet port, the first fraction outlet port, the second fraction outlet port, and the third fraction outlet port are located in the top portion; and
a bottom portion, wherein the top portion and the bottom portion define a channel.

10. The continuous field flow fractionator of claim 9, wherein the channel defines a shape that produces a uniform downstream field.

11. The continuous field flow fractionator of claim 9, wherein the channel defines a shape that produces a non-uniform downstream field.

12. The continuous field flow fractionator of claim 9, wherein the top portion and the bottom portion define a channel having a plurality of zones, each of the plurality of zones applying a different electric field.

13. The continuous field flow fractionator of claim 12, further comprising one or more electrodes located proximate the top portion and one or more electrodes located proximate the bottom portion.

14. The continuous field flow fractionator of claim 9, wherein the top portion and the bottom portion define a channel having a plurality of zones, each of the plurality of zones applying a different temperature gradient.

15. The continuous field flow fractionator of claim 8, further comprising a recirculation loop configured to recirculate a portion of the third flow from the third fraction port back to the sample inject port.

16. A continuous field flow fractionator system comprising:
a plurality of continuous field flow fractionators connected together, wherein each of the continuous field flow fractionators comprises:
a sample inject port;
a frit inlet port;
a first fraction outlet port;
a second fraction outlet port; and
a third fraction outlet port,
wherein a first flow out of the first fraction outlet port is configured to extract a sample-free solvent,
wherein a second flow out of the second fraction outlet port is configured to extract an increased concentration of small molecules of a sample, and
wherein a third flow out of the third faction port is configured to extract a remainder of the sample.

17. The continuous field flow fractionator system of claim 16, wherein at least two of the CFFFs are connected together in series.

18. The continuous field flow fractionator system of claim 16, wherein at least two of the CFFFs are connected together in parallel.
